(19) United States
(12) Patent Application Publication
(10) Pub. No.: US 2016/0140633 A1
(43) Pub. Date: May 19, 2016

(54) PRESENTING USER INTERFACE ELEMENTS AND ACCEPTING INPUT OPTIMISTICALLY WHEN APPLICATION STATE IS UNKNOWN

(71) Applicant: GOOGLE INC., Mountain View, CA (US)

(72) Inventors: Matthew Eric Hiller, New York, NY (US); David Preston Baker, New York, NY (US); Chin Pang Tung, Sunnyvale, CA (US); Stanley N. Marshall, III, Mountain View, CA (US); Mohamed Reza Hussein, San Francisco, CA (US)

(73) Assignee: GOOGLE INC., Mountain View, CA (US)

(21) Appl. No.: 13/729,672

(22) Filed: Dec. 28, 2012

(51) Int. Cl. G06Q 10/10; G06Q 30/02

(52) U.S. Cl. CPC G06Q 30/0609

(57) ABSTRACT

Activation of a link or control button on a user interface before an underlying application status is known. A user requests access to a merchant system's webpage. The merchant system webpage loads and a link is activated. The merchant system begins to determine the user's account status with the remote system while the web page is loading or at any time thereafter. The user initiates a request by clicking, pressing, or otherwise selecting the link on the merchant system's webpage. The merchant system determines whether the user's account status with the remote system is known. If the account status is not known, the merchant system completes the determination. If the account status is known, the merchant system determines whether the action request is available. If the action is available, the request is processed. If the action is not available, the user is notified and the link is disabled.

### TECHNICAL FIELD

The present disclosure relates generally to a control of user interface elements, and more particularly to methods and systems that allow the activation of a link or control button on a user interface before an underlying application status is known.

### BACKGROUND

Electronic commerce, such as online shopping, has been increasingly common since the advent of the Internet. Merchants may develop and maintain an online shopping website that provides a user interface for customers to select products to purchase, and then have their orders processed directly by the merchant or a third party intermediary. Two conventional payment options are generally supported by online merchants, using a financial account (for example, a credit card, debit card, checking account, gift card, or other direct payment device) and using a third party payment processor or a remote payment system (for example, a digital wallet maintained by a remote third party system).

The use of a third party payment processor generally requires the consumer to register for an account and to provide one or more payment options. After registering, the consumer can use the payment options to complete purchases at participating merchant websites. To complete an online purchase using the third party payment processor, the consumer selects a link on the merchant's website and, in response, the consumer's payment is processed by the third party payment processor.

To allow the consumer to select to pay for the purchase via the third party payment processor, the merchant website must communicate with the payment system to confirm that the consumer has a valid account and a payment can be processed. Typically, the merchant website will communicate a query to the third party payment system to determine the consumer's account status while the website is loading. Until the consumer's account status is known, the link or button that the consumer presses to pay via the third party payment processor is grayed out or otherwise marked as unavailable.

### SUMMARY

In certain example aspects described herein, a method for activating a link or control button on a user interface before an underlying application status is known comprises a merchant system that displays the link for selection by a user. The user requests access to the merchant system's web page. The user may or may not be prompted to log onto the web page. The merchant system web page loads and a link on the merchant system web page is activated. The merchant system web page comprises a link to content controlled by the remote system. The content may comprise information controlled by a user account maintained by the remote system. The user's account status with the remote system is determined while the web page is loading or at any time thereafter, including after the user has pressed, clicked, or otherwise selected the link displayed on the user interface of the merchant system web page. A request to authenticate the user's account status is transmitted to the remote system or to a user device, which communicates the request to the remote system.

The user initiates a request by clicking, pressing, or otherwise selecting the link on the merchant system's web page. The merchant system determines whether the user's account status with the remote system is known. If the account status is not known, the merchant system completes the determination. If the account status is known, the merchant system determines whether the user's action request is available. If the action is available, the merchant system and/or remote system processes the request. If the action is not available, the merchant system notifies the user and disables the link.

These and other aspects, objects, features, and advantages of the example embodiments will become apparent to those having ordinary skill in the art upon consideration of the following detailed description of illustrated example embodiments, which include the best mode of carrying out the invention as presently perceived.

### BRIEF DESCRIPTION OF THE DRAWINGS

FIG. 1 is a block diagram depicting a user interface element control system, in accordance with certain example embodiments.

FIG. 2 is a block flow diagram depicting a method for activating a user interface element before an underlying application status is known, in accordance with certain example embodiments.

FIG. 3 is a block flow diagram depicting a method for establishing a merchant account, in accordance with certain example embodiments.

FIG. 4 is a block flow diagram depicting a method for establishing a user account, in accordance with certain example embodiments.

FIG. 5 is a block flow diagram depicting a method for determining the user account status, in accordance with certain example embodiments.

FIG. 6 is a block diagram depicting a computer machine and module, in accordance with certain example embodiments.

### DETAILED DESCRIPTION OF THE EXAMPLE EMBODIMENTS

### Overview

The example embodiments described herein provide computer-implemented techniques for enabling merchant systems to allow the activation of a link or control button on a user interface of a merchant system website before an underlying application status is known. A merchant system registers with a remote system by providing basic identifying information, for example, name, place of business, billing address, web page address, IP address, and banking information or payment processing information needed to direct payment information to the merchant system's payment processor. The remote system assigns the merchant a merchant-specific identifier associated with the merchant system account before communicating the merchant-specific identifier and an API library to the merchant system.

A user registers with the remote system by providing basic identifying information, for example, name, address, phone number, and e-mail address. In an example embodiment, the remote system may further register one or more user device identifiers with the user account. The remote system generates a user account and associates the user's financial payment information with the user's account. For example, the user may provide information for one or more registered financial card accounts, including bank account debit cards, credit cards, or other type of account that can be used to make a purchase (for example, card type, card number, expiration date, security code, and billing address), and the financial account information to which redemptions or other credits are to be credited (for example, card type, card number, expiration date, security code, billing address, financial institution account, and/or financial institution account number).

The user requests access to the merchant system's web page. In an example embodiment, the user has previously logged into a transferrable and recognizable global account that is associated with the merchant system's web page. In this embodiment, the merchant's web page is associated with another web browser, so the user's log in information from one page is transferred to the associated merchant system web page. In an alternative example embodiment, the user has previously logged into the merchant system web page and the user's log in information was stored by the merchant system so that the user is not prompted to re-enter his log in information when returning to the web page. In yet another alternative example embodiment, the user logs into a system account so that the when the user enters a web page the user's registration information is known or provided to the merchant system. In another alternative example embodiment, the user's registration information is known by the remote system or the user is prompted to log into the remote system prior to entering the merchant system web page.

The merchant system web page loads and a link on the merchant system web page is activated, even before the user's account status for the link is known. In an example embodiment, the merchant system web page comprises a link to content controlled by the remote system. The content may comprise information controlled by a user account maintained by the remote system, for example payment information. In an example embodiment, activation of the link comprises the activation of the matter the link controls.

The user's account status with the remote system is determined while the web page is loading or at any time thereafter, including after the user has pressed, clicked, or otherwise selected the link displayed on the user interface of the merchant system web page. In an example embodiment, the merchant system communicates a request to authenticate the user's account status to the remote system. The remote system determines the user's account status and communicates the status to the merchant system. In an alternative example embodiment, the merchant system communicates the request to the user device, which in turn communicates the request to the remote system. In yet another example embodiment, the merchant system is the source of a Javascript module provided by the remote system and the user's web browser mediates between the web page content provided by the merchant system and the functionality provided by the remote system's Javascript library, including browser-to-server communication with the remote system. In another example embodiment, a non-merchant system third party determines the user's account status with the remote system.

The user initiates a request by clicking, pressing, or otherwise selecting the link on the merchant system's web page. In an example embodiment, the user has selected items for purchase from the merchant system and placed these items in the user's shopping cart for check out. The user selects the check out button displayed on the user interface of the merchant system website to indicate a desire to purchase these items using the user's financial information maintained by or contained within the user's remote system account. In an alternative example embodiment, the user has selected an item on the merchant system web page to view additional information, such as consumer reviews or a consumer report.

The consumer reviews or consumer report is maintained by the remote system and in order to view this information, the user is required to have remote system account.

The merchant system determines whether the user's account status with the remote system is known. In an example embodiment, the link on the merchant system's web page is activated and the user initiates the request before the user's account status with the remote system is known. If the account status is not known, the merchant system completes the determination. In an example embodiment, the merchant system determines the user's account status with the remote system at any time before the user initiates the request, while the user is initiating the request, and after the user initiates the request. If the account status is known, the merchant system determines whether the user's action request is available, for example, is the user registered with the remote system. If the action is available, the merchant system and/or remote system processes the request. If the action is not available, the merchant system notifies the user and disables the link.

In an alternative example embodiment, the user requests access to a merchant system application executing on the user device. The merchant system application comprises a link to content controlled by the remote system. The content may comprise information controlled by a user account maintained by the remote system, for example payment information. In an example embodiment, activation of the link comprises the activation of the matter the link controls. The merchant system application loads on the user device and the link is activated, even before the user's account status for the link is known.

The inventive functionality of the invention will be explained in more detail in the following description, read in conjunction with the figures illustrating the program flow.

### Example System Architecture

Turning now to the drawings, in which like numerals indicate like (but not necessarily identical) elements throughout the figures, example embodiments are described in detail.

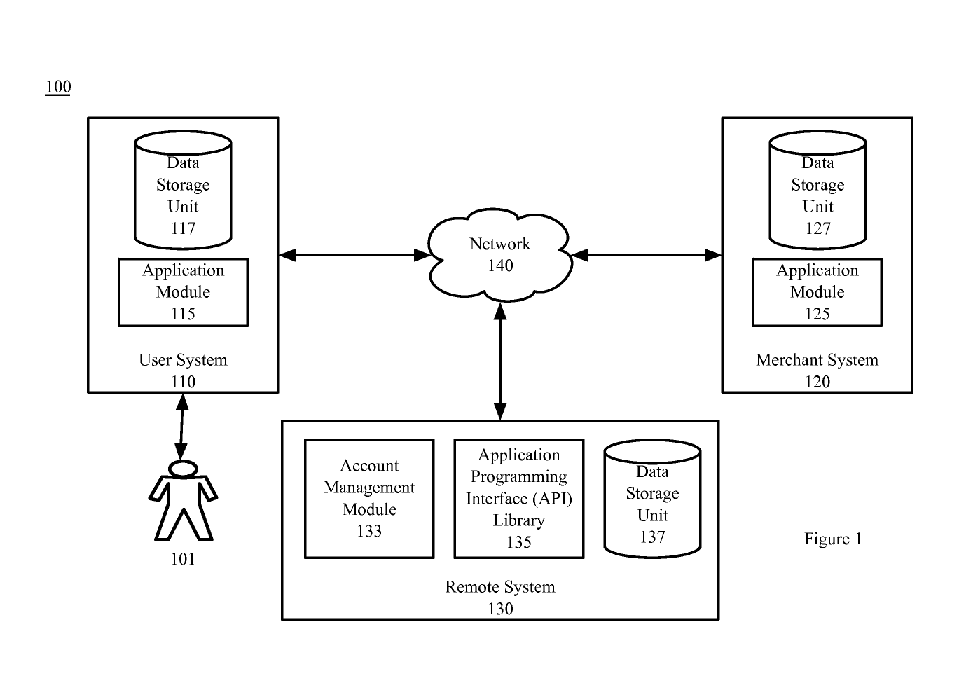

FIG. 1 is a block diagram depicting a user interface element control system, in accordance with certain example embodiments. As depicted in FIG. 1, the exemplary operating environment 100 includes a user system 110, a merchant system 120, and a remote system 130 that are configured to communicate with one another via one or more networks 140.

Each network 140 includes a wired or wireless telecommunication means by which network devices (including devices 110, 120, and 130) can exchange data. For example, each network 140 can be implemented as, or may be a part of, a storage area network (SAN), personal area network (PAN), a metropolitan area network (MAN), a local area network (LAN), a wide area network (WAN), a wireless local area network (WLAN), a virtual private network (VPN), an intranet, an Internet, a mobile telephone network, a card network, Bluetooth, near field communication network (NFC), or any combination thereof, or any other appropriate architecture or system that facilitates the communication of signals, data and/or messages (generally referred to as data). Throughout this specification, it should be understood that the terms “data” and “information” are used interchangeably herein to refer to text, images, audio, video, or any other form of information that can exist in a computer-based environment.

In an example embodiment, each network system (including devices 110, 120, and 130) includes a device having a communication module capable of transmitting and receiving data over the network 140. For example, each network system (including devices 110, 120, and 130) may comprise a server, personal computer, mobile device (for example, notebook computer, tablet computer, netbook computer, personal digital assistant (PDA), video game device, GPS locator device, cellular telephone, Smartphone or other mobile device), a television with one or more processors embedded therein and/or coupled thereto, or other appropriate technology that includes or is coupled to a web browser. In the example embodiment depicted in FIG. 1, the network devices (including devices 110, 120, and 130) are operated by end-users or consumers, merchants with an online store or website, and an online electronic wallet system operator respectively.

In an example embodiment, the user system 110 comprises an application module 115 and a data storage unit 117. The application module 115 includes a program, function, routine, applet or similar entity that exists on and performs its operations on the user system 110. For example, the application module 115 may be one or more of an offline payment application, a digital wallet application, a coupon application, a loyalty card application, another value-added application, a user interface application, a merchant application corresponding to a merchant application module 125, or other suitable application operating on the user system 110. In an example embodiment, the application module 115 may be a browser application such as Google Chrome, Microsoft Internet Explorer, Netscape, Safari, Firefox, or other suitable application for interacting with web page files maintained by the merchant system 120, remote system 130 and/or other network devices. The web page files can include text, graphics, images, sounds, video, and other multimedia or data files that can be transmitted via the network 140. For example, the web page files can include one or more files in Hypertext Markup Language (HTML). The application module 115 can receive web page files from the merchant system 120 and/or remote system 130 and can display the web page files to end users 101 operating the user system 110. The application module 115 may also comprise a mobile application that resides on a mobile device of the user 101. In an example embodiment, the user 101 may access the application module 115 to create, modify, access, or view a remote system 130 account (for example, a digital wallet account, personal account, financial account, or other type of user account) and to access, view, perform a purchase, make a request, or otherwise interact with a merchant system 120 website.

In an example embodiment, the data storage unit 117 can include any local data storage structure on the user system 110 suitable for storing information. In an example embodiment, the data storage unit 117 stores encrypted information such as HTML5 local storage.

In an example embodiment, the merchant system 120 comprises an application module 125 and a data storage unit 127. The application module 125 includes a program, function, routine, applet or similar entity that exists on and performs its operations on the merchant device. For example, the application module 125 may be one or more of a user interface application, a marketplace application, an auction application, an account management application, or other suitable application operating on the merchant system 120 and interacting with the application module 115 on the user system 110. In an example embodiment, the application module 125 may be a web page application suitable for presenting web page files, for example, via a browser application such as Google Chrome, Microsoft Internet Explorer, Netscape, Safari, Firefox, or other suitable application. The web page files can include text, graphics, images, sounds, video, and other multimedia or data files that can be transmitted via the network 140. For example, the web page files can include one or more files in Hypertext Markup Language (HTML). The application module 125 can receive requests for web page files from the user system 110, the merchant system 120, and/or remote system 130 and can present the web page files to end users 101 operating the user system 110. In an example embodiment, the merchant may access the application module 125 to create, modify, access, or view an account with the remote system 130 (for example, a digital wallet account, financial account, or other type of user account) and to create, access, view, modify, otherwise interact the application module 115 on the user system 110. In an alternative example embodiment, the merchant system 110 may access the application module 125 to confirm the application status of the user system 110 by transmitting a request to the remote system 130 prior to processing a user 101 request.

In an example embodiment, the data storage unit 127 can include any local data storage structure on the merchant system 120 suitable for storing information. In an example embodiment, the data storage unit 127 stores encrypted information such as HTML5 local storage.

In an example embodiment, the remote system 130 comprises an account management module 133, an application programming interface (API) library 135, and a data storage unit 137. An example account management module 133 communicates with the user system 110 and the merchant system 120 to register these systems with the remote system 130 and to facilitate requests and receipt of information between the user system 110, merchant system 120, and remote system 130. The account management module 133 manages the registration of user 101 and merchant accounts with the remote system 130. Regarding user account registration, the account management module 133 may generate web-based user interfaces providing the forms necessary for the user 101 to register for a remote system 130 account. For example, the account management module 133 can collect basic user identifying information, registration information on one or more mobile devices, and payment information. In an example embodiment, the user 101 registers one or more financial card accounts, including bank account debit cards, credit cards, gift cards, or other type of financial account that can be used to make a purchase, with the remote system 130 using the account management module 133. In an example embodiment, the registered financial payment information may be used to complete a purchase by the user 101 with the merchant system 120. In an example embodiment, the user account information is stored in a user account in the data storage unit 137.

Regarding merchant account registration, the account management module 133 may provide user interfaces that provide the forms necessary for a merchant to register account information with the remote system 130. In an example embodiment, merchant account information comprises merchant name, physical address, billing address, and merchant identifier. In an example embodiment, merchants may provide one or more merchant-specific encryption keys. In an example embodiment, the merchant account information is stored in a merchant account in the data storage unit 137.

In an example embodiment, the application management module 133 provides the merchant system 120 with access to the API library 135. An example API library comprises forms associated with user interfaces required to interface the remote system 130 with the merchant system's 120 purchase flow. Example API libraries include a JavaScript libraries.

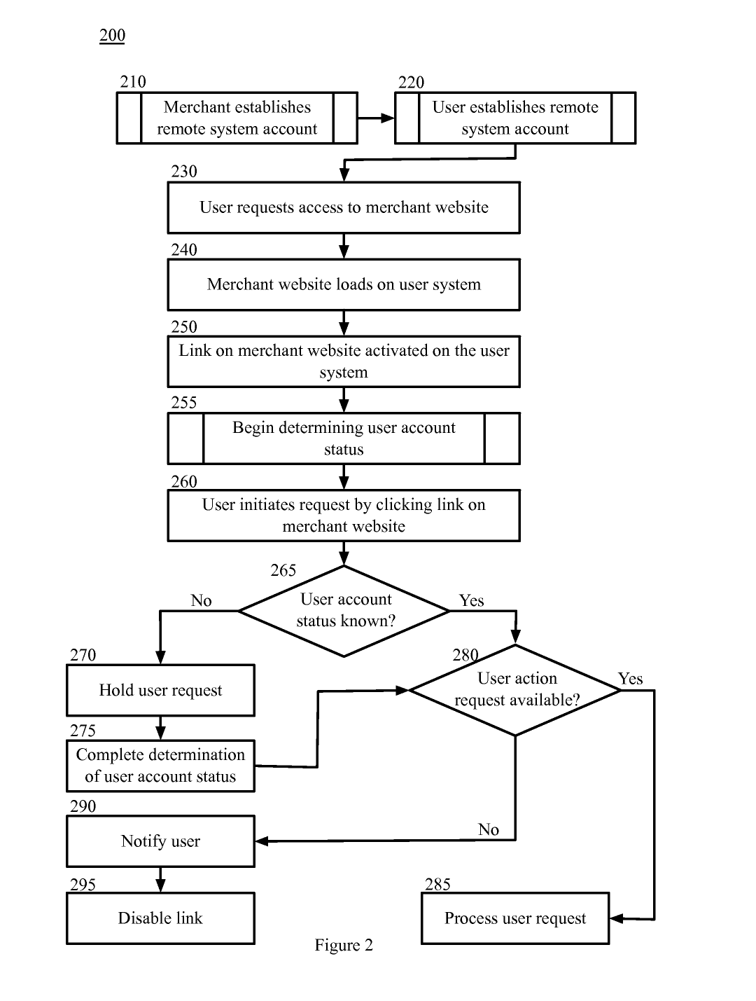

The components of the example operating environment 100 are described hereinafter with reference to the example methods illustrated in FIGS. 2-5.

### Example Process

FIG. 2 is a block flow diagram depicting a method for activating a user interface element before an underlying application status is known, in accordance with certain example embodiments. The method 200 is described with reference to the components illustrated in FIG. 1.

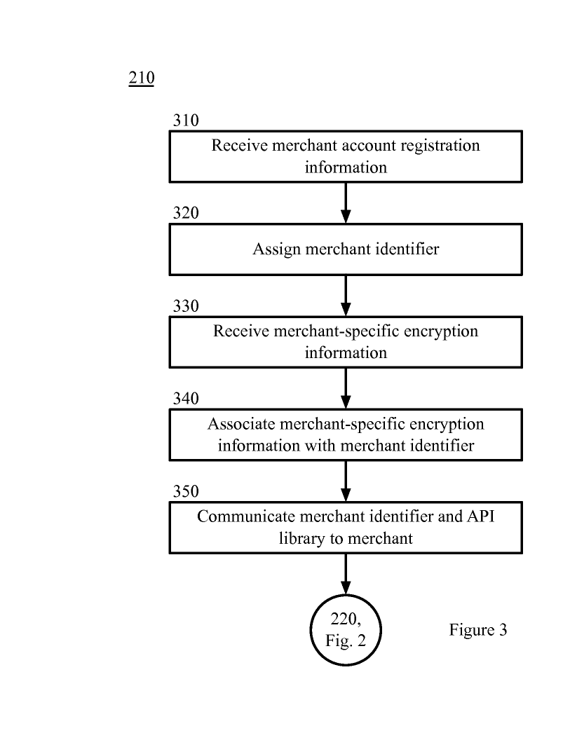

In block 210, a merchant establishes a remote system 130 account. In an example embodiment, the remote system 130 provides a user interface where the merchant system 120 can register basic identifying information, for example, name, place of business, billing address, web page address, IP address, and banking information or payment processing information needed to direct payment information to the merchant system's 120 payment processor. The method for establishing a merchant system 120 account with the remote system 130 is described in more detail hereinafter with reference to the methods described in FIG. 3.

FIG. 3 is a block flow diagram depicting a method for establishing a merchant system 120 account with the remote system 130 in accordance with certain example embodiments, as referenced in block 210. The method 210 is described with reference to the components illustrated in FIG. 1.

In an example embodiment, a merchant system 120 desires to provide users 101 with the ability to access a remote system 130 account via a link on a web page of the merchant system. For example, the merchant system 120 operates an online shopping web page and desires to provide users 101 with the ability to pay using a remote system 130 digital wallet account. In an alternative example embodiment, the merchant system 120 operates a web page and desires to provide users 101 with the ability to access material maintained by the remote system 130 via a link on the merchant system's web page. For example, the merchant system 120 operates an online shopping web page and desires to provide users 101 with the ability to access reviews of a product maintained by the remote system 130, wherein the user 101 is required to have a remote system 130 account to access the reviews. In an alternative example embodiment, the user 101 has an account with the remote system 130, but the account is not in good standing for review access. For example, the remote system 130 may require a subscription fee and the user's 101 payment of those fees is past due.

In block 310, the remote system 130 receives the merchant system's 120 registration information. In an example embodiment, the merchant system 120 completes the registration forms provided by the remote system 130 and submits the information via the network 140. In an example embodiment, the remote system 130 creates an account record for the merchant system 120.

In block 320, the remote system 130 assigns a merchant-specific identifier to the merchant system 120. In an example embodiment, the merchant-specific identifier is associated with the merchant system 120 account and saved in the data storage unit 137.

In block 330, the remote system 130 receives a merchant-specific encryption key from the merchant system 120.

In block 340, the merchant-specific key is associated with the merchant-specific identifier. In an example embodiment, the merchant-specific key is an encryption key such as a public key of a public/private key pair and is used to encrypt the user's 101 full payment information prior to communicating the payment information to the merchant system 120.

In block 350, the remote system 130 communicates the merchant-specific identifier and an online API library to the merchant system 120. In an example embodiment, the remote system 130 comprises the APIs and user interfaces needed to integrate the remote system 130 into the merchant system's existing web page flow. In an alternative example embodiment, the remote system 130 API may be integrated into a mobile phone purchase flow, for example native iOS or Android API. In an example embodiment, the API library 135 allows the merchant system 120 to request masked digital wallet information for user-selected objects from the remote system 130, which is returned to the merchant system 120 for display and logic in their purchase flow with the user 101. In an example embodiment, the request may further involve user interactions with a buyer interface generated by the remote system 130 to authenticate the user 101 and/or select digital wallet instruments.

The method 210 then proceeds to block 220 in FIG. 2.

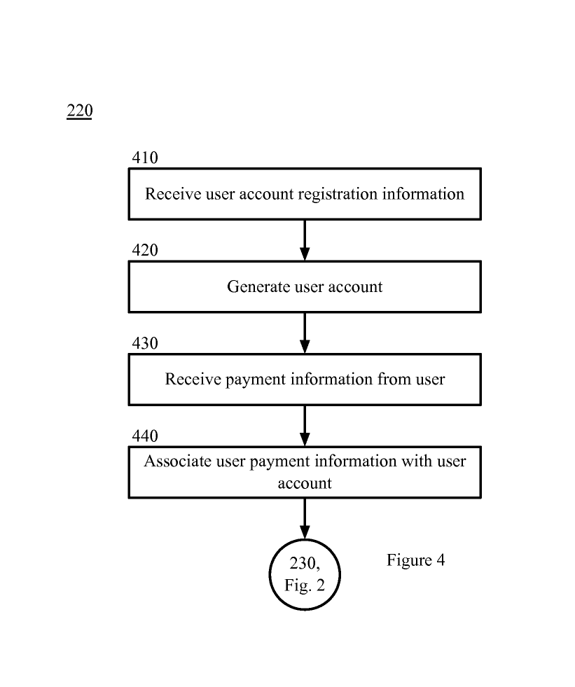

Returning to FIG. 2, in block 220, a user 101 establishes a remote system 130 account. In an example embodiment, the remote system 130 provides a user interface where the user 101 can register basic identifying information, for example, name, address, phone number, and e-mail address. The method for establishing a user 101 account with the remote system 130 is described in more detail herein after with reference to the methods described in FIG. 4.

FIG. 4 is a block flow diagram depicting a method for establishing a user 101 account with the remote system 130 in accordance with certain example embodiments, as referenced in block 220. The method 220 is described with reference to the components illustrated in FIG. 1.

In block 410, the remote system 130 receives the user's 101 registration information. In an example embodiment, the user 101 completes the registration forms provided by the remote system 130 and submits the information via the network 140.

In block 420, the remote system 130 creates a user account. In an example embodiment, the remote system 130 assigns the user 101 a user-specific identifier. In an example embodiment, the remote system 130 may further register one or more user device identifiers with the user 101 account. The remote system 130 may assign a user device identifier to each user device registered. In certain example embodiments, the user device identifier may be used in place or, or in addition to, the user-specific identifier to verify an online transaction has been initiated by a user 101 registered with the remote system 130.

In block 430, the remote system receives payment information. In an example embodiment, the user 101 can register information for one or more registered financial card accounts, including bank account debit cards, credit cards, or other type of account that can be used to make a purchase (for example, card type, card number, expiration date, security code, and billing address), the financial account information redemptions are to be credited to (for example, card type, card number, expiration date, security code, billing address, financial institution account, and/or financial institution account number).

In block 440, the remote system 130 associates the user's payment information with the user 101 account. In an example embodiment, the user's payment information is stored in the user 101 account in the data storage unit 137.

The method 220 then proceeds to block 230 in FIG. 2.

Returning to FIG. 2, in block 230, the user 101 requests access to the merchant system's 120 web page. In an example embodiment, the user 101 has previously logged into a transferrable and recognizable global account that is associated with the merchant system's 120 web page. In this case, if the user 101 is logged into his global account and the merchant's system accepts the registration information from the global account, the user 101 will be automatically logged into the merchant system 120. For example, the merchant system's 120 web page is associated with the global account, so the user's log in information from the global account is transferred to the associated merchant system 120 web page. For example, the user 101 has previously logged into a Yahoo, Google, or Facebook account, so that when the user 101 enters another web page associated with, or that accepts login information from, his Yahoo, Google, or Facebook account, the user is not prompted to re-enter his log in information.

In another example embodiment, the merchant system 120 may not require log in information to view the merchant system 120 web page. However, if the user 101 is logged into a global account, then the user's 101 information is available from the user system 110. The available account information for the user 101 can then be used instead of, or together with, specific merchant system 120 information to optimistically enable a control on the merchant system's website, as described hereinafter.

In an alternative example embodiment, the user 101 has previously logged into the merchant system 120 web page and the user's log in information was stored by the merchant system 120 so that the user 101 is not prompted to re-enter his log in information when returning to the web page. In yet another alternative example embodiment, the user 101 is not required to log into the merchant system 120 web page when initially opening the page. In yet another alternative example embodiment, the user 101 logs into a system account so that the when the user 101 enters a web page the user's 101 registration information is known or provided to the merchant system 120. In another alternative example embodiment, the user's 101 registration information is known by the remote system 130 or the user is prompted to log into the remote system 130 prior to being presented the merchant system 120 web page.

In block 240, the merchant system 120 web page loads. In an example embodiment, the merchant system 120 web page comprises a link to content controlled by the remote system 130. The content may comprise information controlled by a user 101 account maintained by the remote system 130, for example payment information.

In block 250, a link on the merchant system 120 web page is activated. In an example embodiment, the link is activated while the merchant system 120 web page is loading. In an example embodiment, activation of the link comprises the activation of the matter the link controls. For example, activation of the link on the web page allows the user 101 to select the link for further action controlled by the link, so that the link is not grayed- out or otherwise not selectable by the user 101. In an example embodiment, the link is displayed as a button on the user interface of the merchant system 120 web page. The button is displayed as available or active for the user 101 to press or otherwise select the button to attempt to access the content controlled by the link. In an alternative example embodiment, the link is displayed as a URL link in the text displayed on the user interface of the merchant system 120 web page. The link is displayed a selectable by the user 101 so that the user may click, press or otherwise select the link to access the content controlled by the link. In an alternative example embodiment, the link is a tab displayed on the user interface of the merchant system 120 website. The tab is displayed as selectable by the user 101 so that the user may click, press or otherwise select the tab to access content controlled by the link.

For example, the API library 135 may generate a button for display on the purchase page of the merchant system's 120 web page. The button is activated by the merchant system 120 and displayed on the user interface of the web page. Clicking the button by the user 101 communicates to the merchant system 120 that the user intends to use his digital wallet account maintained by the remote system 130 to complete the purchase.

In an example embodiment, selection of the link by the user 101 accesses content controlled by the remote system 130. Access to the content is allowed only after the user's 101 account status with the remote system 130 is known. For example, the selection of the link by the user 101 may access the user's financial information controlled or otherwise maintained by the remote system 130 so that the user may not access or use the financial information until the merchant system 120 confirms that the user 101 has an account with the remote system 130.

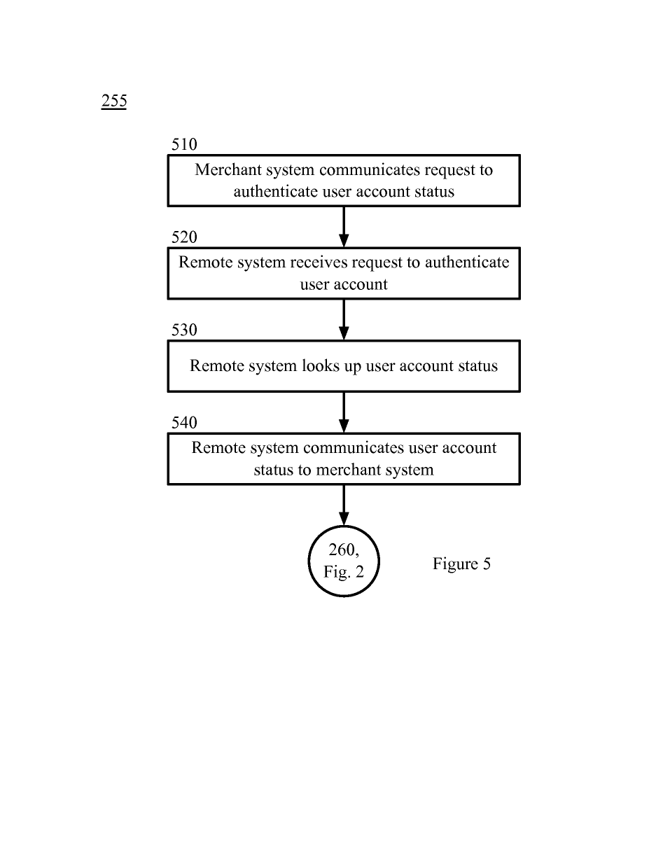

In block 255 the user's 101 account status with the remote system 130 is determined. The method for determining the user's 101 account status with the remote system 130 is described in more detail herein with reference to the methods described in FIG. 5.

FIG. 5 is a block flow diagram depicting a method for determining the user's 101 account status with the remote system 130 in accordance with certain example embodiments, as referenced in block 255. The method 255 is described with reference to the components illustrated in FIG. 1. In an example embodiment, the methods described in FIG. 5 may occur at any time while the merchant system 120 web page is loading or at any time thereafter, including after the user 101 has pressed, clicked or otherwise selected the link displayed on the user interface of the merchant system 120 web page.

In block 510, the merchant system 120 communicates a request to authenticate the user's 101 account status to the remote system 130. In an example embodiment, the merchant system 120 communicates a request comprising an identification of the user 101, for example, the user-specific identifier or specific log-in information, to the remote system 130. In an alternative example embodiment, the merchant system 120 communicates a request to the user device to communicate the user-specific identifier or other identifying information to the remote system 130. For example, an executable instruction on the merchant system's 120 web page presented on the user system 110, or an executable instruction within a merchant system's 120 application running on the user system 110, can initiate the request to authenticate the user's 101 account status to the remote system 130. The request can comprise user 101 information sufficient for the remote system 130 to determine whether the control should be active for the user 101, such as the user's 101 merchant system log in information, global account log in information, user-specific identification, or other suitable information for the user 101.

In another example embodiment, the merchant system 120 is the source of a Javascript module provided by the remote system 130 and the user's 101 web browser mediates between the web page content provided by the merchant system 120 and the functionality provided by the remote system's 130 Javascript library, including browser-to-server communication with the remote system 130. In another example embodiment, a non-merchant system third party determines the user's 101 account status with the remote system 130.

In block 520, the remote system 130 receives the request to authenticate the user's 101 account.

In block 530 the remote system 130 looks up the user's 101 account status. In an example embodiment, the remote system 130 receives the information for the user 101 from the merchant system 120 or the user device and determines the user's account status by referencing the account status associated with the user 101, based on the user 101 information received in the request. In an example embodiment, the user's 101 account status is active, wherein the user 101 is registered with the remote system 130. In an alternative example embodiment, the user's 101 account status is inactive, deactivated, or incomplete, wherein the user 101 is not registered with the remote system 130, or the remote system 130 account does not contain the information required by the merchant system 120.

In block 540, the remote system 130 communicates the user's 101 account status to the merchant system 120. In an alternative example embodiment, the remote system 130 communicates the user's 101 account status to the user device, which may use the account status information directly and/or in turn communicate the account status to the merchant system 120.

The method 255 then proceeds to block 260 in FIG. 2. In an example embodiment, the methods described in FIG. 5 are completed before proceeding to block 260 in FIG. 2. In an alternative example embodiment, the methods described in FIG. 5 are being performed simultaneously with the methods described in blocks 260 through 270 in FIG. 2. In yet another alternative example embodiment, the methods described in FIG. 5 are performed in full or in part after the methods described in blocks 260 through 270 in FIG. 2.

Returning to FIG. 2, in block 260, the user 101 initiates a request by clicking, pressing, or otherwise selecting the link on the merchant system 120 web page. In an example embodiment, by selecting the link, the user 101 is requesting access to further information or processing of information controlled or maintained by the remote system 130.

In an example embodiment, the user 101 has selected items for purchase from the merchant system 120 and placed these items in the user's shopping cart for check out. The user selects the check out button displayed on the user interface of the merchant system 120 website to indicate a desire to purchase these items using the user's financial information maintained by or contained within the user's remote system 130 account. By clicking on the button, the user communicates to the merchant system 120 his desire to use his digital wallet account to complete the purchase.

In an alternative example embodiment, the user has selected an item on the merchant system 120 web page to view additional information, such as consumer reviews or a consumer report. The consumer reviews or consumer report is maintained by the remote system 130 and in order to view this information, the user 101 is required to have remote system 130 account. The user 101 selects the consumer report button displayed on the user interface to view the consumer report. By clicking the link, the user 101 communicates his desire to the merchant system 120 to use his remote system 130 account to view the consumer report.

In block 265, the merchant system 120 or the user system 110 determines whether the user's 101 account status with the remote system 130 is known. In an example embodiment, the user's account status was communicated to the merchant system 120 and/or the user system 110 by the remote system 130 or the user device in block 540 in FIG. 5. In an alternative example embodiment, the user's account status has not yet been communicated to the merchant system 120 and/or the user system 110.

If the user's 101 account status is not yet known, the method proceeds to block 270.

In block 270, the merchant system 120 and/or the user system 110 holds the user's 101 request. In an example embodiment, the user 101 has clicked, pressed, or otherwise selected a link that controls information maintained by the remote system 130 and the merchant system 120 and/or the user system 110 cannot process the user's request until confirmation is received that the user 101 has an account with the remote system 130. If the user's 101 account status is not known by the merchant system 120 and/or the user system 110 at the time the user 101 clicks, presses, or otherwise selects the link, the merchant system 120 and/or the user system 110 cannot process the user's request. The merchant system 110 and/or the user system 110 receives the user's request, but does not process the request until the user's account status is known.

In block 275, the determination of the user's 101 account status is completed. In an example embodiment, the methods described in FIG. 5 are performed in part or in whole to determine the user's account status with the remote system 130.

The method 200 proceeds to block 280.

Returning to block 265, if the user's account status is known, the method proceeds from block 265 directly to block 280.

In block 280, the merchant system 120 and/or the user system 110 determines whether the user's requested action is available. In an example embodiment, the merchant system 120 and/or the user system 110 determines whether the user's account with the remote system 130 supports the action requested by the user 101. For example, the merchant system 120 and/or the user system 110 may send a request to the remote system 130 to provide the user's financial information required to complete the check out procedure for the items in the user's shopping cart described above. In an alternative example embodiment, the merchant system 120 and/or the user system 110 may send a request to the remote system 130 to provide the user 101 with access to information maintained by the remote system 130, for example, the consumer report information described above.

If the action requested by the user 101 is available, the method 200 proceeds to block 285.

In block 285, the merchant system 120, the user system 110, and/or the remote system 130 process the user's 101 request. In an example embodiment, the user's payment information is processed and the user 101 successfully completes the check out process with the merchant system 120. In an alternative example embodiment, the user is provided with the consumer report information maintained by the remote system 130.

The method 200 terminates once the user's 101 request is processed.

Returning to block 280, if the user's action request is not available, the method 200 proceeds to block 290. For example, if the user 101 is not registered with the remote system accessible by the link, the user 101 is not granted the action accessible by the link.

In block 290, the merchant system 120 notifies the user 101 that the requested action is unavailable. In an example embodiment, the user 101 is provided with additional options, such as providing alternative payment information or registering with the remote system 130.

In block 295, the merchant system 120 disables the link on the user interface of the web page and the method 200 is terminated.

### Other Example Embodiments

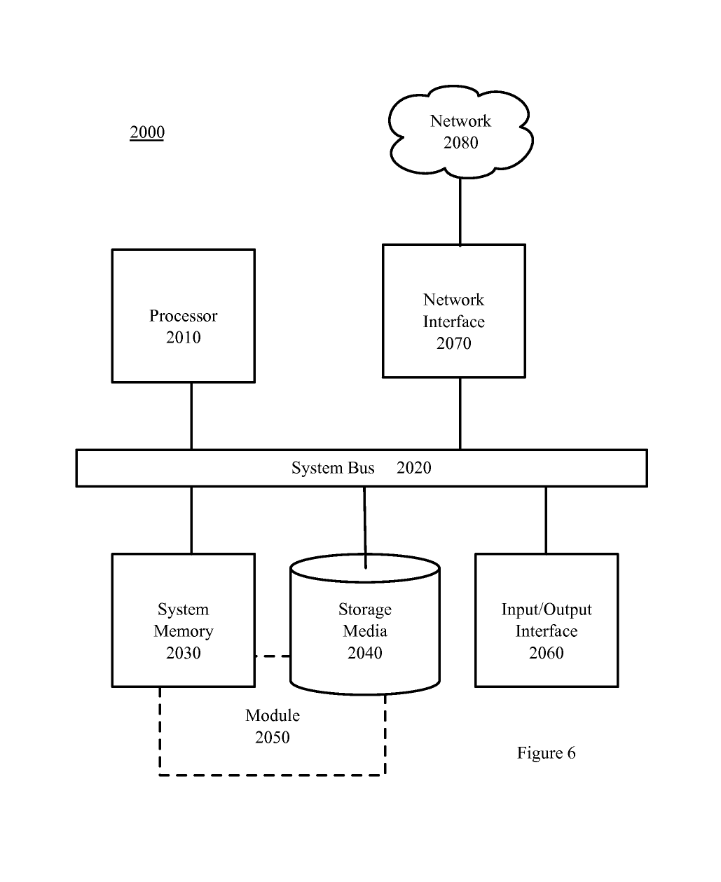

FIG. 6 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non- volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A computer-implemented method to activate merchant application links to content maintained by a computer management system prior to determining that the computing management system can perform action associated with selection of the links, comprising:
receiving, by one or more merchant computing devices operated by a merchant, a request from a user computing device operated by a user to access a merchant application;
activating, by the one or more merchant computing devices operated by the merchant, a merchant application link to content maintained by a computer management system, the activated link displayed on a user interface of the user computing device prior to a determination that the computer management system maintains credentials associated with the user that will enable the computer management system to perform an action associated with selection of the link;
receiving, by the one or more merchant computing devices operated by the merchant, an input from the user computing device indicating a selection of the link from the user interface;
accepting, by the one or more merchant computing devices operated by the merchant, the selection of the link while pending the action associated with the selection of the link;
determining, by the one or more merchant computing devices operated by the merchant, that the computer management system maintains the credentials associated with the user;
determining, by the one or more merchant computing devices operated by the merchant, that the action associated with selection of the link is available to the user based on a determination that the computer management system maintains the credentials associated with the user; and
processing, by the one or more merchant computing devices operated by the merchant, the action associated with the selection of the link based on the determination that the action associated with the selection of the link is available to the user.

2. The computer-implemented method of claim 1, further comprising:
receiving, by the computer management system, registration information from the merchant; and
receiving, by the computer management system, registration information from the user.

3. The computer-implemented method of claim 1, wherein receiving a request from the user computing device to access the merchant application further comprises receiving the user's log in information for the computer management system.

4. The computer-implemented method of claim 1, wherein the action requested by the user comprises a request to process shopping cart data using financial information maintained by the computer management system.

5. The computer-implemented method of claim 1, wherein the action requested by the user comprises a request to view information maintained by the computer management system.

6. The computer-implemented method of claim 1, wherein determining that the computer management system maintains credentials associated with the user comprises:
communicating, by the merchant network device operated by the merchant, a request to the computer management system to determine that the computer management system maintains the credentials associated with the user; and
receiving, by the merchant network device operated by the merchant, a confirmation that the computer management system maintains the credentials associated with the user.

7. The computer-implemented method of claim 1, wherein determining that the computer management system maintains credentials associated with the user comprises:
receiving, by the user device operated by the user and from the merchant network device operated by the merchant, a request to determine that the computer management system maintains the credentials associated with the user;
communicating, by the user device operated by the user, a request to the remote computer management system to determine that the computer management system maintains the credentials associated with the user;
receiving, by the user device operated by the user and from the computer management system, a confirmation that the computer management system maintains the credentials associated with the user; and
transmitting, by the user device operated by the user and to the merchant network device operated by the merchant, the confirmation that the computer management system maintains the credentials associated with the user.

8. The computer-implemented method of claim 7, further comprising receiving, by the merchant network device operated by the merchant and from the user device operated by the user, the confirmation that the computer management system maintains the credentials associated with the user.

9. The computer-implemented method of claim 1, wherein the application is a web page.

10. A computer program product, comprising:
a non-transitory computer-readable medium having computer-readable program instructions embodied therein that when executed by a computer activate merchant application links prior to determining that an action associated with selection of the links can be performed, the computer-readable program instructions comprising:
computer-readable program instructions to receive a request from a user computing device operated by a user to access a merchant application;
computer-readable program instructions to activate a merchant application link to content maintained by a computer management system, the activated link displayed on a user interface of the user computing device prior to a determination that the remote computer management system maintains credentials associated with the user that will enable the computer management system to perform an action associated with selection of the link;
computer-readable program instructions to receive an input from the user computing device indicating a selection of the link from the user interface;
computer-readable program instructions to accept the selection of the link while pending the action associated with the selection of the link;
computer-readable program instructions to determine that the computer management system maintains the credentials associated with the user; and
computer-readable program instructions to process the action associated with the selection of the link based on the determination that the action associated with the selection of the link is available to the user.

11. The computer program product of claim 10, further comprising computer-readable program instructions to determine that the action requested by selection of the link is available to the user based on a determination that the computer management system maintains credentials associated with the user.

12. The computer program product of claim 10, wherein receiving a request from the user computing device to access the application further comprises computer-readable program instructions to receive the user's log in information for the computer management system.

13. The computer program product of claim 10, wherein the action requested by the user comprises a request to process shopping cart data using financial information maintained by the computer management system.

14. The computer program product of claim 10, wherein the action requested by the user comprises a request to view information maintained by the computer management system.

15. The computer program product of claim 10, wherein determining that the computer management system maintains credentials associated with the user comprises:
computer-readable program instructions to communicate a request to the computer management system to determine that the computer management system maintains the credentials associated with the user; and
computer-readable program instructions to receive a confirmation that the computer management system maintains the credentials associated with the user.

16. The computer program product of claim 10, wherein determining that the computer management system maintains credentials associated with the user comprises:
computer-readable program instructions to receive a request to determine that the computer management system maintains the credentials associated with the user;
computer-readable program instructions to communicate a request to the remote computer management system to determine that the computer management system maintains the credentials associated with the user;
computer-readable program instructions to receive a confirmation that the computer management system maintains the credentials associated with the user; and
computer-readable program instructions to transmit the confirmation that the computer management system maintains the credentials associated with the user.

17. A system to activate merchant application links prior to determining that an action associated with selection of the links can be performed, comprising:
a storage resource;
a network module; and
a processor communicatively coupled to the storage resource and the network module, wherein the processor executes application code instructions that are stored in the storage resource to cause the system to:
activate a merchant application link to content maintained by a computer management system, the activated link displayed on a user interface of a user computing device prior to a determination that the computer management system maintains credentials associated with the user that will enable the computer management system to perform an action associated with selection of the link;
receive an input from the user computing device indicating a selection of the link from the user computing device;
accept the selection of the link while pending the action associated with the selection of the link;
determine that the computer management system maintains the credentials associated with the user; and
process the action associated with the selection of the link based on the determination that the action associated with the selection of the link is available to the user.

18. The system of claim 17, wherein the processor is further configured to execute computer-executable instructions stored in the storage resource to cause the system to receive a request from the user computing device operated by the user to access the merchant application.

19. The system of claim 17, wherein the processor is further configured to execute computer-executable instructions stored in the storage resource to cause the system to determine that the action associated with selection of the link is available to the user based on a determination that the computer management system maintains the credentials associated with the user.

20. The system of claim 18, wherein receiving a request from the user computing device to access the application further comprises receiving the user's log in information for the computer management system.

21. The system of claim 17, wherein the action requested by the user comprises a request to process shopping cart data using financial information maintained by the computer management system.

22. The system of claim 17, wherein the action requested by the user comprises a request to view information maintained by the computer management system.

23. The system of claim 17, wherein determining that the computer management system maintains credentials associated with the user comprises:
communicating a request to the computer management system to determine that the computer management system maintains the credentials associated with the user; and
receiving a confirmation that the computer management system maintains the credentials associated with the user.

24. The system of claim 17, wherein determining that the computer management system maintains credentials associated with the user comprises:
receiving a request to determine that the computer management system maintains the credentials associated with the user;
communicating a request to the computer management system to determine that the computer management system maintains the credentials associated with the user;
receiving a confirmation that the computer management system maintains the credentials associated with the user; and
transmitting the confirmation that the computer management system maintains the credentials associated with the user.

25. A computer-implemented method to activate merchant application links prior to determining that an action associated with selection of the links can be performed, comprising:
receiving, by a merchant computing device operated by a merchant, a request from a user computing device operated by a user to access an application;
activating, by the merchant computing device operated by the merchant, an application link to content maintained by a computer management system, the activated link displayed on a user interface of the user computing device prior to a determination that the computer management system does not maintain credentials associated with the user that would enable the computer management system to perform an action associated with selection of the link;
receiving, by the merchant computing device operated by the merchant, an action request by the user initiated by selecting the link from the user interface;
pending, by the merchant computing device operated by the merchant, the action associated with selection of the link;
determining, by the merchant computing device operated by the merchant, that the action associated with selection of the link is not available based on a determination that the computer management system does not maintain the credentials associated with the user; and
deactivating, by the merchant computing device operated by the merchant, the link on the user interface.

26. The computer-implemented method of claim 25, further comprising notifying, by the merchant computing device operated by the merchant, the user that the action is not available.

27. The computer-implemented method of claim 25, wherein receiving a request from the user computing device to access the application further comprises receiving the user's log in information for the computer management system.

28. The computer-implemented method of claim 25, wherein the action associated with selection of the link comprises one of a request to process shopping cart data using financial information maintained by the computer management system and a request to view information maintained by the computer management system.

29. The computer-implemented method of claim 25, wherein determining that the action associated with selection of the link is not available comprises:
communicating, by the merchant computing device operated by the merchant, a request to the computer management system to determine whether the computer management system maintains the credentials associated with the user; and
receiving, by the merchant computing device operated by the merchant, a confirmation that the computer management system does not maintain the credentials associated with the user.

30. The computer-implemented method of claim 25, wherein determining that the action associated with selection of the link is not available comprises:
receiving, by the user computing device operated by the user and from the merchant computing device operated by the merchant, a request to determine whether the remote computer management system maintains the credentials associated with the user;
communicating, by the user computing device operated by the user, a request to the computer management system to determine whether the computer management system maintains the credentials associated with the user;
receiving, by the user computing device operated by the user and from the computer management system, a confirmation that the computer management system does not maintain the credentials associated with the user; and
transmitting, by the user computing device operated by the user and to the merchant computing device operated by the merchant, the confirmation that the computer management system does not maintain the credentials associated with the user.
